(19) United States
(12) Patent Application Publication
(10) Pub. No.: US 2009/0142024 A1
(43) Pub. Date: Jun. 4, 2009

(54) RIGID ATTACHMENT OF OPTICAL FIBER CABLE TO ANOTHER STRUCTURE USING LASER WELDING

(75) Inventors: Vinay Varma, Cypress, TX (US); Stephen L. Crow, Tyler, TX (US); Martin P. Coronado, Cypress, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/271,280

(22) Filed: Nov. 14, 2008

Related U.S. Application Data
(60) Provisional application No. 60/991,420, filed on Nov. 30, 2007.

(51) Int. Cl. G02B 6/44

(52) U.S. Cl. 385/100

(57) ABSTRACT

A conductor mounting configuration includes a conductor having a signal carrying portion, and insulative portion radially outwardly disposed of the signal carrying portion and a jacket radially outwardly disposed of the insulative portion; an intermediary material having a thickness selected to accommodate a heat based fusion to the jacket while requiring a heat load of less than that associated with damage to the conductor; and a heat fusion affixing the conductor to the intermediate material and method.

### CROSS REFERENCE TO RELATED APPLICATION

The present application claims priority to U.S. Provisional Patent Application Ser. No. 60/991,420, filed Nov. 30, 2007, the entire contents of which are specifically incorporated herein by reference.

### BACKGROUND

In the hydrocarbon recovery art, there has long been interest in greater monitoring and control of the downhole environment in order to enhance production of target fluids while eschewing those having little or no commercial value. Such interest has over the years led to significant movements toward instrumentation. With instrumentation, conductors are needed to transmit information to remote locations including surface locations. While hydraulic control lines have been a mainstay for connection with the downhole environment, their use requires a large amount of stored excess hydraulic fluid. Such storage increases a footprint of a rig and is thus undesirable. Electrical conductors have helped to eliminate or at least reduce the hydraulic fluid necessary on the rig. Optic fibers have more recently been found to be even of more interest due to higher data speeds and the ability to use the fiber itself as a monitoring device. In order to use optic fiber though, it must be connected in some way to the tool string being run in the hole. While there are many currently existing ways to secure fiber or electric cable to the string, not every situation is addressed. The art will thus continually appreciate new and different ways to secure conductors so that the possibilities available to address particular situations are plentiful and ubiquitous.

### SUMMARY

A conductor mounting configuration includes a conductor having a signal carrying portion, and insulative portion radially outwardly disposed of the signal carrying portion and a jacket radially outwardly disposed of the insulative portion; an intermediary material having a thickness selected to accommodate a heat based fusion to the jacket while requiring a heat load of less than that associated with damage to the conductor; and a heat fusion affixing the conductor to the intermediate material.

A method for affixing a conductor to a separate structure includes selecting an intermediary material including at least a portion thereof having a thickness ranging from about equal to a thickness of a jacket of the conductor to about double the thickness of the jacket; bringing the conductor into contact with a portion of the intermediary material having the stated thickness range; inducing a heat fusion between the portion of the intermediary material contacting the jacket and the jacket; and fusing a portion of the intermediary material not fused to the jacket to the separate structure.

A method for affixing a conductor to a separate structure includes matching an intermediary material thickness of an intermediary material depending from a conductor to a target downhole component thickness; and fusing a portion of the intermediary material not fused to the jacket to the separate structure.

### BRIEF DESCRIPTION OF THE DRAWINGS

Referring now to the drawings wherein like elements are numbered alike in the several Figures:

FIG. 1 is a schematic illustration of an encapsulated conductor fastened to an intermediary structure;

FIG. 2 is the image of FIG. 1 rotated 180° and fastened to an attachment structure; and

FIG. 3 is a schematic illustration of an alternate intermediate material configuration.

### DETAILED DESCRIPTION

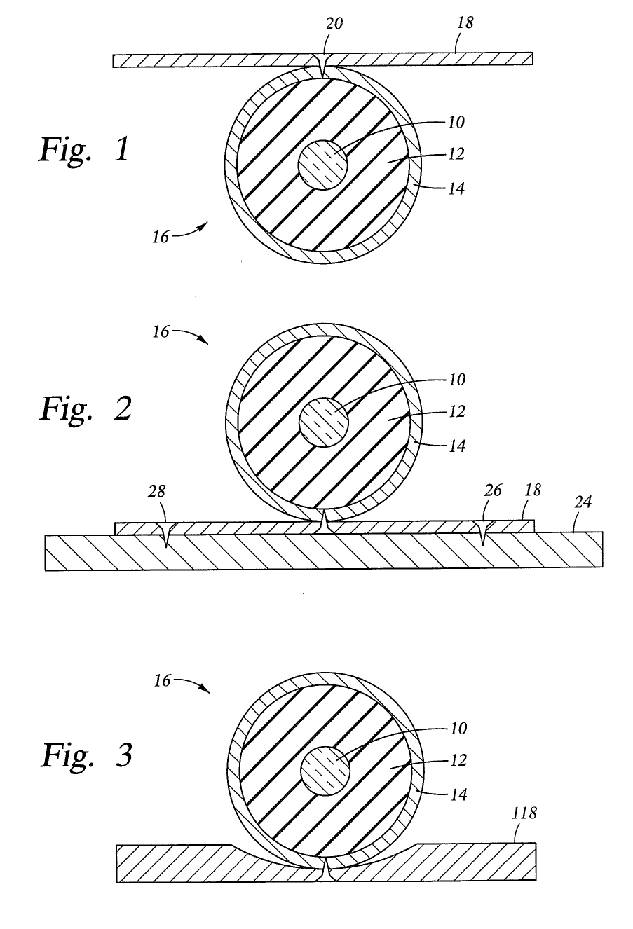

Referring to FIG. 1, an optic fiber 10 (or other signal carrying portion or conductor) is illustrated embedded in an insulative material 12. The insulative material includes a heat dissipative property and in one embodiment may be one of High-temperature Acrylate, Polyimid, Polyethylethylketone (PEEK), etc., for example. The material may also be formed of a combination of materials as listed or otherwise. Importantly, the material selected must be capable of withstanding a temperature associated with any one of a number of heat based fusion techniques such as, for example, a welding method to be applied. In one embodiment, a laser welding method is employed since such method maintains the temperature of the material surrounding the weld at below about 230° C. Other welding methods that do not cause temperature of the surrounding material to exceed about 230° C. are also contemplated. In one embodiment, a temperature range is desirably maintained between 175° C. and 215° C. Welding methods that create a higher heat load can also be used but selection of insulative material will change accordingly to one capable of withstanding such higher heat load. Radially outwardly positioned of the insulative material is a tubular structure or jacket 14 comprising a weldable material such as steel, inconel, stainless steel, etc. These three components make up a tubing encapsulated conductor 16.

The tubing encapsulated conductor 16 is illustrated in FIG. 1, adjacent to an intermediary material 18. The intermediary material comprises a weldable material and in one embodiment, a weldable material that is also compatible with the material of the structure 14. The material 18 will range in thickness for different embodiments hereof from between about the same thickness as the material of the structure 14 to about double the thickness of the material of the structure 14. Weld line 20 is visible in FIG. 1 illustrating the penetration thereof through the intermediary material 18 and into the jacket 14 to permanently attach the intermediary material 18 to the conductor 16. The penetration of the weld is one reason that the range of thickness of the intermediary material 18 is selected as stated. Were the material 18 too thin, it would burn through too easily and have poor fusion with the jacket 14; were the material 18 too thick, too much heat would be required to liquefy the same in the weld joint and the temperature of the insulative material 12 would exceed its capability for withstanding heat, and consequently potentially damage the optic fiber 10. In other words, the insulative material has a thickness selected to accommodate a heat based fusion technique while requiring a heat load of less than that associated with damage to the conductor. This will as noted above be in one embodiment less than above 230° C.

Heat loading of the conductor 16 is also the reason for the existence of the intermediary material. A component of a downhole tool to which the conductor is to be affixed will invariably be of a substantially greater thickness than the material thickness of jacket 14. This presented a problem that the present inventors solved through the particular construction and method disclosed herein. A conductor undergoing a welding process to a downhole component would experience a heat load well in excess of the capacity of the insulative material simply because in order to melt the downhole component, a lot more heat is necessary. This can potentially result in at least some damage to the fiber 10 and possibly in rupture of the jacket 14. In the event jacket 14 is ruptured, the resulting shock wave generally breaks the fiber 10 and the conductor 16 is useless, at least beyond the breakage area.

Due to the controlled thickness of the intermediary material 18, the heat load is as noted above, controlled. The intermediary material itself provides additional weld area where an effective weld can be used to affix the conductor to the component. In one embodiment, illustrated in FIG. 2, the intermediary material 18 is welded to a downhole component 24. Evident is the location of the weld lines 26 and 28, spaced from the conductor 16. The spacing allows for the dissipation of the heat necessary to create a melt in the component 24, thereby joining the intermediary material 18 and conductor 16 therethrough to the component 24. It is to be appreciated that the thicker the material of component 24, the thicker the material of intermediate material is desirable within the range as noted above.

In an alternate embodiment, referring to FIG. 3, intermediary material 118 does not have a consistent thickness over its surface area but rather is thicker at one or more portions thereof generally not in contact with conductor 16. In keeping with the foregoing disclosure, that portion of intermediate material 118 that is in contact with and in fact is welded to or will be welded to conductor 16, will have a material thickness in a range of about equal to the thickness of jacket 14 to about double the thickness of jacket 14 for the same reasons indicated above. Other portions of intermediate material 118, however, are made thicker in order to appropriately endure the greater heat load required for a weld to penetrate a larger component 24. It will be appreciated that one or more sections of intermediary material 18 may have the thicker profile, and that the illustration of FIG. 3 is exemplary rather than restrictive.

The above combination of conductor 16 and intermediary material 18, after being welded together, may be installed on one surface of a shroud material that is then helically coiled to produce a tubular structure to be used as a shroud at a downhole tool. One of ordinary skill in the art will be familiar with the helical coiling of a sheet of shroud material to produce a tubular structure. This method for creation of a tubular shroud is well known in the art and does not require any further teaching. The combination disclosed herein is welded linearly onto the strip of shroud material and thus, when the shroud material is coiled into a tubular structure, the combination assumes a helix itself at an inside dimension of the resulting tubular shroud. It is to be appreciated that a shroud is used only as an example, and other downhole components can be substituted therefore.

While preferred embodiments have been shown and described, modifications and substitutions may be made thereto without departing from the spirit and scope of the invention. Accordingly, it is to be understood that the present invention has been described by way of illustrations and not limitation.

1. A conductor mounting configuration comprising:
a conductor having a signal carrying portion, and insulative portion radially outwardly disposed of the signal carrying portion and a jacket radially outwardly disposed of the insulative portion;
an intermediary material having a thickness selected to accommodate a heat based fusion to the jacket while requiring a heat load of less than that associated with damage to the conductor; and
a heat fusion affixing the conductor to the intermediate material.

2. The conductor mounting configuration as claimed in claim 1 wherein the signal carrying portion is one or more optic fibers.

3. The conductor mounting configuration as claimed in claim 1 wherein the jacket is metallic.

4. The conductor mounting configuration as claimed in claim 1 wherein the insulative material is one of high-temperature Acrylate, polyimid, Polyethylethylketone and combinations including at least one of the foregoing.

5. The conductor mounting configuration as claimed in claim 1 wherein the intermediary material is metallic.

6. The conductor mounting configuration as claimed in claim 1 wherein the intermediary material is compatible with the jacket material.

7. The conductor mounting configuration as claimed in claim 1 wherein the intermediary material is of a constant thickness over its surface area.

8. The conductor mounting configuration as claimed in claim 1 wherein the intermediary material is of non-constant thickness over its surface area.

9. The conductor mounting configuration as claimed in claim 8 wherein the intermediary material is of a thickness at locations in contact with the jacket that are of about the same thickness as the jacket to about double the thickness of the jacket.

10. The conductor mounting configuration as claimed in claim 8 wherein at least one area of the intermediary material not in contact with the jacket is of more than double the thickness of the jacket material.

11. The conductor mounting configuration as claimed in claim 10 wherein the at least one area of thicker intermediary material is of a thickness selected to accommodate a fusion to a material of a component thicker than double the thickness of the jacket.

12. The conductor mounting configuration as claimed in claim 1 wherein the intermediary material is of a thickness of about the same thickness as the jacket to about double the thickness of the jacket.

13. The conductor mounting configuration as claimed in claim 1 wherein the intermediary material is the same as the jacket material.

14. The conductor mounting configuration as claimed in claim 1 wherein the insulative material is heat tolerant to about 230° C.

15. The conductor mounting configuration as claimed in claim 1 wherein the intermediary material undergoes a heat based fusion joining with the jacket at about 175° C. to about 215° C.

16. The conductor mounting configuration as claimed in claim 1 wherein the heat based fusion is a weld.

17. The conductor mounting configuration as claimed in claim 16 wherein the weld is a laser weld.

18. A method for affixing a conductor to a separate structure comprising:
selecting an intermediary material including at least a portion thereof having a thickness ranging from about equal to a thickness of a jacket of the conductor to about double the thickness of the jacket;
bringing the conductor into contact with a portion of the intermediary material having the stated thickness range;
inducing a heat fusion between the portion of the intermediary material contacting the jacket and the jacket; and
fusing a portion of the intermediary material not fused to the jacket to the separate structure.

19. A method for affixing a conductor to a separate structure comprising:
matching an intermediary material thickness of an intermediary material depending from a conductor to a target downhole component thickness; and
fusing a portion of the intermediary material not fused to the jacket to the separate structure.
